(19) United States
(12) Patent Application Publication
(10) Pub. No.: US 2025/0095610 A1
(43) Pub. Date: Mar. 20, 2025

(54) BENDER FOR ALTERING PITCH OF STRINGED INSTRUMENT

(71) Applicant: Daniel Patrick King, Powell, OH (US)

(72) Inventor: Daniel Patrick King, Powell, OH (US)

(21) Appl. No.: 18/827,218

(22) Filed: Sep. 6, 2024

Related U.S. Application Data
(60) Provisional application No. 63/539,187, filed on Sep. 19, 2023.

(51) Int. Cl. G10D 3/147; G10D 1/08

(52) U.S. Cl. CPC G10D 3/147; G10D 1/085

(57) ABSTRACT

The invention relates to the field of musical instruments such as a guitar and, more particularly a steel guitar and devices for modifying their pitch known as benders. The bender includes at least one pedal or lever; at least one linear potentiometer responsive to movement of a pedal or lever, the potentiometer being able to produce output voltage signals; a servo motor corresponding to each potentiometer; at least one cam capable of engaging one of the strings; a logic controller configured and programmed to control a servo motor such that the servo motor moves a cam into and/or out of engagement with the associated string and thereby modifies the pitch of that string.

### FIELD OF THE INVENTION

The invention relates to the field of musical instruments such as a guitar and, more particularly a steel guitar and devices for modifying their pitch.

### BACKGROUND

One of the unique capabilities of a guitar is its ability to be tuned differently for different purposes. The typical guitar has six strings with E-B-G-D-A-E as a standard tuning of the strings. Likewise, a typical guitar has frets that, when pressed between two fret wires with a fingertip, change the note by one-half step per the fret position. E.g., placing a finger in fret five will increase the strings pitch by five half steps. Many guitarists, after having played for several years, find interesting new combinations of notes and chords by changing the base tuning to achieve different note combinations and styles.

Eventually players discovered entirely new capabilities for guitar by using a slide. With a slide the player does not make contact between frets on the neck to make a note but rather uses a slide to contact strings at specific points to make sounds. A slide can be made from any hard material but is typically metal or glass. When playing the guitar flat on a stand or on the guitarist's lap the slide is typically solid metal. The term for this style of play is referred to as steel guitar or just a “steel”. When playing slide, or steel, it is common to have unintended notes result when contacting extraneous strings causing discordant notes and a bad musical outcome. With extreme care, hours of practice, and likely specific re-tuning, this problem can be overcome. For performing guitarists, this re-tuning can result in needing multiple guitars during a show to be able to quickly change between tunings depending on the song being played.

An innovation, called a pedal steel guitar, emerged which enabled players to use mechanical rods and levers to partially alleviate the extraneous note problem by changing the pitch of a string during play. This proved to be a brilliant solution to the problem of re-tuning and provided an entirely new medium for guitarists to be creative. However, due to the complex mechanical requirements, it also resulted in a very heavy instrument that is very difficult to build, transport, and set up. Likewise, pedal steels are notoriously expensive and even difficult to find in most parts of the world. Consequently, the commitment to make traditional pedal steel guitars, considering such a large investment in time and equipment, is a daunting proposition which also contributes to the availability issue.

This design describes a system for a guitar, hereafter called Musical Instrument String Bender, that enables the bending of guitar strings, like pedal steel operation, that leverages electronic innovation to make the capability applicable to many types of guitars. The Stringed Instrument Bender is designed to be an answer to the cost and availability of pedal steel guitars and/or to enable a player to achieve multiple tunings and real-time pitch changes, with fewer guitars.

### SUMMARY OF THE INVENTION

The system, as introduced, relates to a set of components and configurations that work together to enable a guitar to use pedals and levers, driven by electronics and motors, to change the pitch of the guitar strings to accurate values while it is being played.

The Musical Instrument String Bender (MISB) captures the playability and dynamic nature of the pedal steel guitar but with the portability of a lap steel or standard fretted electric guitar. For lap steel players, it provides the player with the dynamic tuning capability of a pedal steel and potentially cuts down the number of guitars needed for a performance, all while maintaining their portability. For pedal steel players, it provides a much more portable guitar while enabling even more flexibility in tuning and bending. For newer players, the stringed instrument bender provides an opportunity to enter a world of dynamic playing that may have been out of reach due to either expense or availability—or, often, both.

The MISB uses inexpensive digital and electromechanical components to act similarly to a mechanical pedal steel. Unlike a purely mechanical configuration, which can be configured with only one base tuning and carefully tuned and adjusted, the stringed instrument bender provides more dynamic adjustability. The operation of the system can be compared to a drive by wire system in a modern automobile, cutting down on weight, improving safety for the car, and enabling dynamic steering (e.g., leisure versus performance driving scenarios). Lastly, by using commonly available components, the MISB can be maintained more easily and even be customized to the player's needs.

While the device uses electronics and motors to replace mechanical configuration, the nature of the guitar does not change. A guitar having the MISB in place is not required to have the system powered on to make sound. There is essentially no change nor effect to the pickups and related electronics that make sound from the guitar. Likewise, an important benefit of the MISB is that it maintains the analog nature and sound of a guitar while only using electronics to add dynamic playability. For instance, if the MISB were added to a common fretted electric guitar, a player could play it like any other electric guitar. The MISB becomes active when powered on, thereby augmenting the guitar with the capabilities herein described.

The MISB may include a pedal unit, a guitar unit, and a configuration unit. The pedal unit typically sits on the floor in front of the player and has a set of spring-loaded pedals which are connected to a central processor using signal wires. The processor interprets the control inputs and sends a signal to the guitar unit which adjusts the pitch of one or more strings of the guitar.

The guitar unit is attached to a guitar and has a series of motors that move to apply or release pressure against the guitar strings-thereby changing the pitch of the string during play. The relative pressure on the pedal results in a relative pressure change on the string(s) and, consequently, a resulting pitch change. For example, with a guitar tuned to an E chord (E-B-G#-E-B-E), the player might configure pedal one to reduce the pressure on string three to drop the G# to a G making an E minor chord. The pedal unit and guitar unit may communicate electronically using a standard connector such as a Cat5 cable having RJ45 connectors—like those used in many home network systems.

The last of the three components, the configuration unit, enables the player to fine-tune adjustments to the pitch of the strings when the pedals are pressed and enables recall of configurations to change the guitar setup. As an example of this, instead of having two separate necks, which is common for pedal steels, the configuration unit can enable switching between tunings, so the player has just one guitar and just one neck. This is consistent with reducing weight and cost of the instrument. These configurations may align with a particular song or sound. These configurations are traditionally referred to as a copedent by the pedal steel community and reflect how the guitar is both tuned and played—referring to the effect of the pedals and levers. With the MISB, copedents are stored electronically and can be created, saved, and recalled as needed. For example, the player, in preparation for the next number, can recall the C6 or E9¹ tuning configuration from data on digital storage using the configuration unit. C6 tuning and E9 tuning are the two most common tunings for a 10-string pedal steel guitar. Likewise, building on the earlier example of the E tuning, the player can use the configuration unit to recall a copedent that changes the guitar from an E tuning to a standard tuning (E-B-G-D-A-E) where pedal one 1 is changed to raise string 1 by a half step and pedal 2 raises string 4 by a full step. With this change strings 2, 3, and 4 form a major fourth chord when pedals 1 and 2 are pressed simultaneously-giving the player a new advantage for a particular song.

Like the communication between the pedal unit and the guitar unit, the configuration unit may communicate electronically with the pedal unit, which holds the central processor, using a standard cable such as a Cat5 cable having an RJ45 connector. More information on the use of the optional configuration unit is presented later in this document.

One key feature of this separation of components is that the system can be expanded and/or quickly reconfigured. As an example, this may enable a guitarist to switch between a fretted guitar, played while standing, to a lap steel, played while sitting, merely by disconnecting and re-connecting the Cat5 cable to the new guitar and recalling the appropriate copedent.

A common and supported scenario is such that a single control will operate more than one servo/string combination. This is to support the case where a guitar has two strings with the same note value but an octave apart. In this example, when a single pedal is pressed, both strings should move from the same start note to the same end note only each being an octave different. Despite the pedal moving two strings from the same start note to the same end note, fine-tuning will likely dictate that the starting and ending value of the servos is different based on notes in different octaves will have different string thickness and therefore require different pressure to arrive at the end note.

While wireless communication capabilities are commonplace, wired connections between the three units of the MISB have been used to explain the invention. The use of Cat5 cabling between the pedal unit and the guitar unit is for 1) reliability of the connection during play (i.e., wireless interference during play is unlikely acceptable) and 2) to provide power to the motors in the guitar unit. However, future iterations of the system may give way to the use of wireless technologies, particularly for communication between the configuration unit and the pedal unit. The configuration unit could be eliminated by using a mobile operating system (e.g., smart phone) and wireless protocol (e.g., Bluetooth) for communication.

The MISB is conceived as a more portable version of the pedal steel—but—with this new portability comes new opportunities. It is difficult to predict what an experienced guitarist might do with the availability of a dynamic tuning capability. Whether a fretted player, a slide player, or both, a guitarist will likely find new uses, new sounds, and new techniques with the ability to bend notes by pressing a pedal on the floor in front of them.

An additional potential use of this dynamic capability is to overcome the restriction on right-handedness. One common shortcoming of steel guitars is they are exclusively right-handed. The flexibility of the MISB, and the availability as a kit, could make it usable by right or left-handed players.

One of the expected benefits is to add the dynamic capability to an existing guitar. Part of the benefit of the MISB is that it is designed to be easily added to a commonly available fretted electric guitar or lap steel. The lap steel is typically less expensive than a fretted guitar because it doesn't have the precision requirements of a fretted guitar with its thin neck and frets. With a minimal investment in a lap steel and the MISB kit, a player can have dynamic playability at a much lower cost. The anticipated outcome is to make the capability available to a much wider range of players.

A traditional pedal steel platform is potentially included in the benefits of the MISB components. As mentioned earlier, the pedal steel is a unique type of guitar as it is typically made with a metal frame and string bending mechanism. It is conceivable, and an intended implementation of the MISB, to be installed on a pedal steel frame while replacing the mechanical bending mechanism. Whether manufactured as a MISB guitar or replacing the mechanical system of an existing pedal steel guitar, the MISB will enable it to be played like the mechanical version.

Another financially beneficial aspect is that the pedal unit and associated configuration unit may be used with multiple equipped guitars as alluded to earlier.

Being developed with economics in mind, it is conceivable that a player or a guitar shop would be able to keep parts inventory on-hand to enable inexpensive repairs in the event of issues or wear. The MISB is designed with common electronic components that are readily available at many computer and electronics stores or via online purchase.

The MISB provides a complete solution to change the way the guitar can be played and opens new doors for players that adopt the capabilities. For pedal steel players, it is a chance to cut down on the amount of gear, the weight, and setup and tear-down time while keeping that great sound that is so unique. See the Comparison and Differentiation section later in the document for more details.

### BRIEF DESCRIPTION OF THE DRAWINGS

FIG. 1: Illustration of a pedal and pedal unit.

FIG. 2: View of the backplane of the pedal unit.

FIG. 3: Exploded view of the guitar unit motor, drive rod, and cam.

FIG. 4: Image of the guitar unit, showing the cams in slots aligned with the instrument strings.

FIG. 5: Diagram of an in-built guitar unit.

FIG. 6: Diagram of the wiring of potentiometers, logic controller, and servo motors (motor controller not included).

FIG. 7: Illustration of Configuration Unit screen display.

FIG. 8: Illustration of the fine-tuning interface of the Configuration Unit

FIG. 9: Diagram of the process of fine-tuning with the Configuration Unit

### DETAILED DESCRIPTION

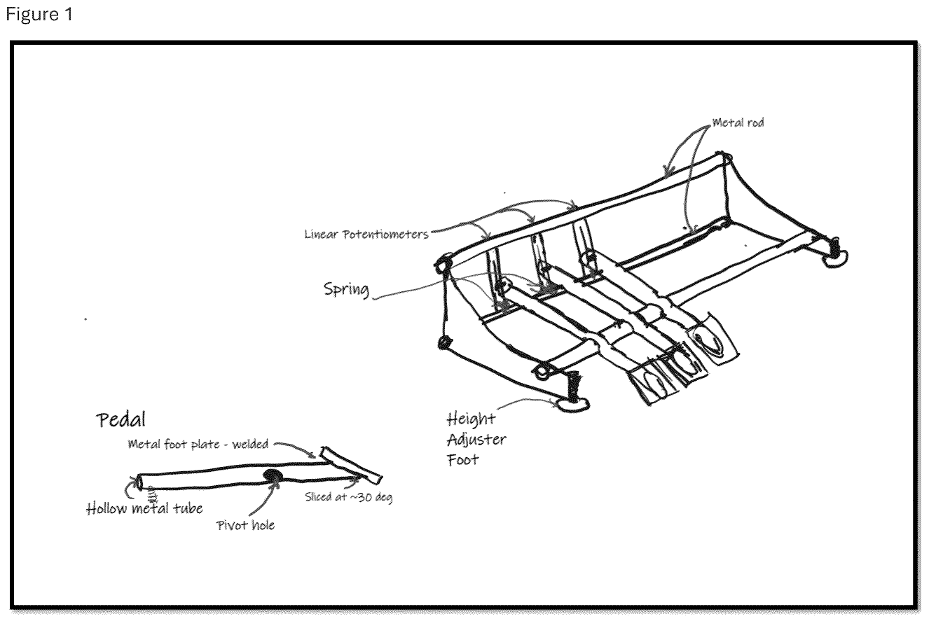

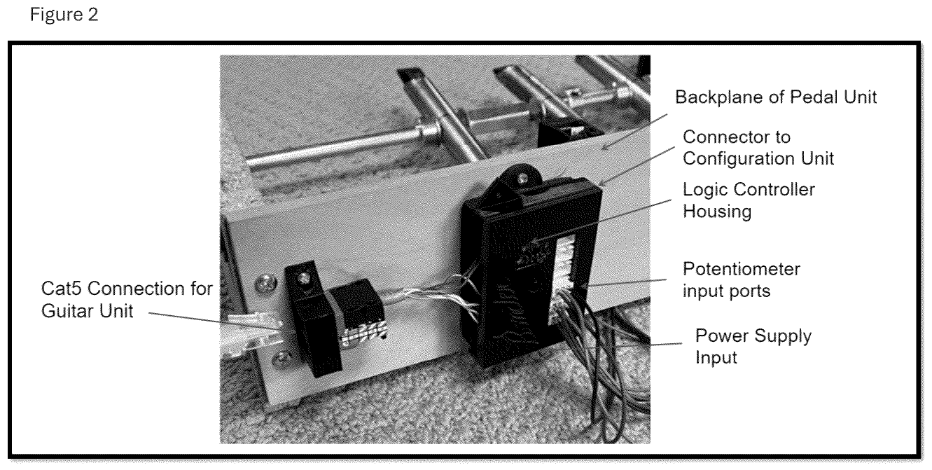

A pedal unit (PU) in accordance with one embodiment of the invention is shown in FIGS. 1 and 2. The PU has two physical features that enable functions of the MISB system. As its name suggests, the PU is the platform for the attachment of pedals. In addition, it also houses the central processor and main connection points for two other units of the MISB system. The pedal unit sits on the floor at the player's feet and is sometimes affixed to the ground or weighted down to prevent movement. The anchoring of the unit will depend on the area (stage) where it is being played. The PU. As shown in FIG. 1, is designed to enable the player to adjust the height of the pedals by turning the anchors on the front of the unit to adjust up or down. The PU illustrated in FIG. 2 includes the central controller, power connection, the connection for the configuration unit, and the RJ45 connector for the CAT5 cable connection to the stringed instrument.

A lever can be of several types: a pedal, which is operated by the player's feet; a knee lever, operated by the player's knee; or another type of lever that may be operated by the hand or wrist. A lever moves a potentiometer which in turn changes the value of the input into the logic controller. The controls are connected electronically to the central processor on the PU. The use of identical potentiometers is important across all control types to achieve consistent input for the logic controller and reduce the number of variations needed during configuration.

Each control is designed to result in a range-of-motion that spans the entire range of the potentiometer (i.e., from zero volts to 100% of supplied input voltage). The starting position is the zero point of the potentiometer. Each control is held at the zero position by spring tension. The spring tension of the lever will vary based on the type of control and on the player's preference. For instance, a particular player may prefer that the pedals require more force to press to increase the “feel” of the pedals while choosing lighter resistance on all knee levers. Standard springs are used and can be swapped for different tension to change the feel of the pedal and response action as desired.

Levers can be in or elsewhere outside of the pedal unit. If a knee lever is desired, which are typical on pedal steel applications, or any other type of lever, such a lever can be placed to be comfortably accessible by the player such as near the knee. The connection for the lever requires a longer cable and plugged into a slot in the PU input connector.

See FIG. 1 in the Figures and Diagrams document for detail on these physical features.

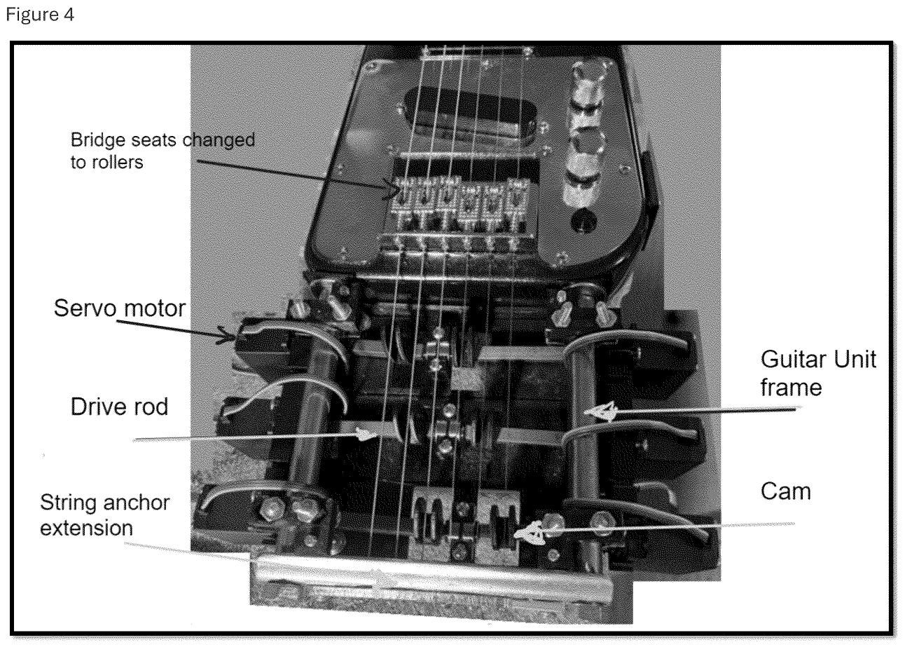

The GU is the platform for hosting motors, shafts, and cams, is attached to a guitar, and has the function of changing the tension on the strings. One example of a guitar unit (GU) is shown in FIG. 4. Attachment is such that a cam is located as close to, and aligned with, one guitar string so that, when the shaft is turned by the motor, it applies or releases pressure on the string to increase or decrease its pitch respectively. The cam is attached to a drive rod which is attached at one end to a bearing and at the other end to a servo motor. The bearing is in place to reduce any radial friction and to keep the rod and cam rigid to eliminate any side-to-side or up-and-down movement. The drive train is anchored to the Guitar Unit frame with the bearing anchor at one end and the servo motor anchor.

To enable the GU to bend a string, a guitar string is passed through the string anchor, through the center of the cam under the tensioners, over the roller bridge, and strung as usual to the guitar's tuning machines. The string must then be tuned normally to the base tuning.

Each servo motor, therefore, acts upon one string by turning the drive rod which moves the cam against the assigned string. Pressure is applied or released by the string tensioner at the end of the cam.

There is a maximum of 6 servos in the current iteration-3 on either side of the guitar unit. The cam is rigidly held in place on the rod to assure it does not slip side-to-side on the rod nor lag against the pressure it applies on the string.

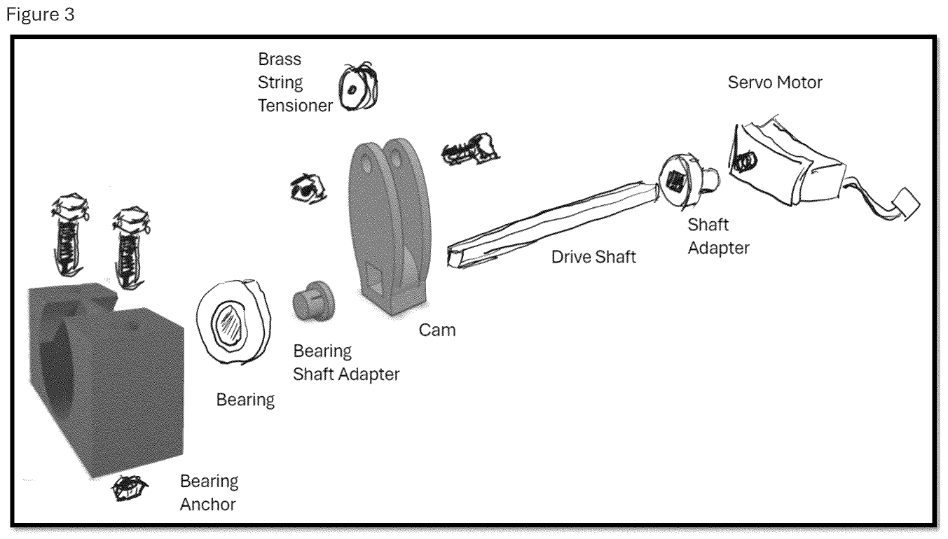

Each cam is shaped in a specific way but may have subtle variations depending on several factors such as string weight and base tension on the strings. The cam shown in FIG. 3 has a curved shape where it contacts the string to apply consistent pressure on the string as the motor turns the drive rod. Consistent pressure is important for playability and increased string life. The opening in the cam to accept the drive rod is the same dimensions as the drive rod. The opening enables the cam to slide tightly into place on the drive rod to align to the string with which it is associated and stay in place directly centered on the string without wavering side-to-side. It is intended that one motor/drive shaft/cam combination is assigned to a single string and never has more than one cam on a drive shaft/motor grouping.

On a standard six string guitar, one motor will operate one string. When connected to a guitar with more than 6 strings, which the MISB may be configured to accommodate, the cams may be aligned to operate only on the desired strings. This is achieved by the lateral placement of the cam on the drive shaft shown in FIG. 3. This ability is another facet that can be set by the player and can result in unique and artistic configurations. Strings that do not require pitch change, as in the case of early pedal steel guitars, will not have a cam aligned to them.

The rigidity required to house the guitar unit is consistent with a wooden solid body electric guitar or a pedal steel metal frame. The ability to mount the guitar unit also requires mounting points with enough room to provide a reliable and sturdy mounting.

A two-note pitch change on any given string is implied in the design with the MISB. This guideline is consistent with a musical requirement and is typical of the functionality with a pedal steel guitar.

The guitar unit can be integrated with a guitar in several ways. As mentioned above, an add-on guitar unit is designed for a common standard lap steel and for other electric solid body guitar types. The add-on unit requires the guitar body to have roughly six inches from the bridge to the butt of the guitar with enough width to house the guitar unit (roughly five and ½ inches). This area must be free of any components of the guitar other than the body/frame to allow for the additional string length behind the bridge to the string anchor and provides a location for the motor assembly. On some lap steels it may be possible to extend the length of the guitar to allow for the additional string length behind the bridge and provide a location for the guitar unit as FIG. 4 illustrates. The add-on involves anchors to be placed into the end of the guitar via holes drilled into the butt of the guitar to provide the necessary strength to maintain the string torque. It is required that the anchors are at the proper position and angle to enable the proper operation of the system. An installation kit and guide may accompany the add-on unit to assure proper installation and operation.

Two scenarios for in-built guitars are retrofits and purpose-built guitar bodies. A retrofit will enable an existing standard guitar to be reconfigured to add a guitar unit. This will involve cosmetic changes to the guitar and result in removing material of the guitar body behind the bridge to support placement of the guitar unit. Partial disassembly and reassembly of the guitar will be necessary. Not all electric guitars will be suitable for a retrofit due to available area behind the bridge and/or shape of the guitar body.

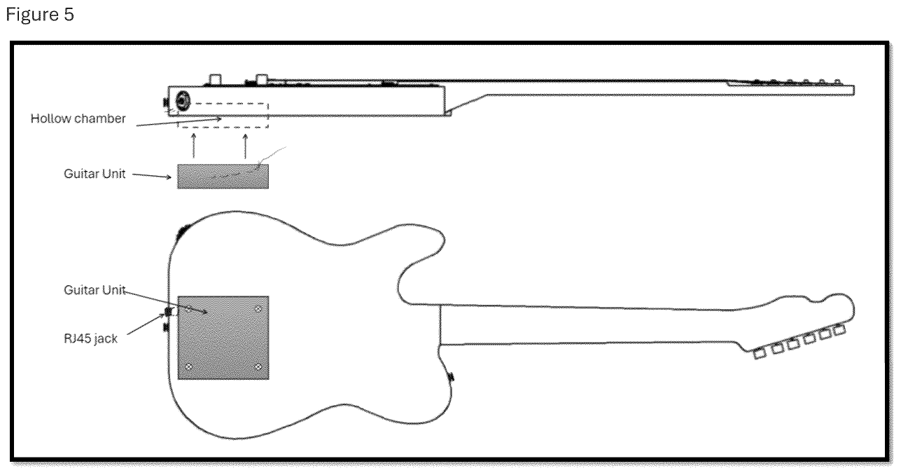

For in-built embodiments, there are several possibilities for guitar bodies designed to include the guitar unit. The possibilities are not necessary to describe here other than to say that the guitar bodies, or even complete guitars, may be designed specifically for the MISB guitar unit. FIG. 5 also provides an overview of a guitar body with a factory-built guitar unit. It is an intended implementation that guitar bodies may be shaped to accommodate the MISB unit. A pedal steel frame is also an example of either a retrofit and/or purpose-built guitar body. An intended implementation of the MISB system is to support up to a 10-string pedal steel guitar.

The guitar unit may have different physical dimensions to allow for these differences in guitar body or platform.

Whether adding on or building in a MISB guitar unit to a guitar there are several changes to note. The bridge may be reconfigured from using typical v-style saddles to using roller saddles as shown in FIG. 4. Using rollers in the bridge allow for easier motion and reduce both stress on the strings and unexpected or abrupt pitch changes. The MISB installation assumes the proper setting of the guitar's intonation after any changes to the bridge and saddles before proceeding to any further MISB configuration. Another change involves the string anchor bar on a typical bridge. This anchor bar can be removed or adjusted such that it does not interfere with the additional string length to accommodate the MISB guitar unit. The MISB string anchor is configured with string eyelets to extend the length between the anchors and the bridge which creates the location for the servo motors, shafts, and cams to operate.

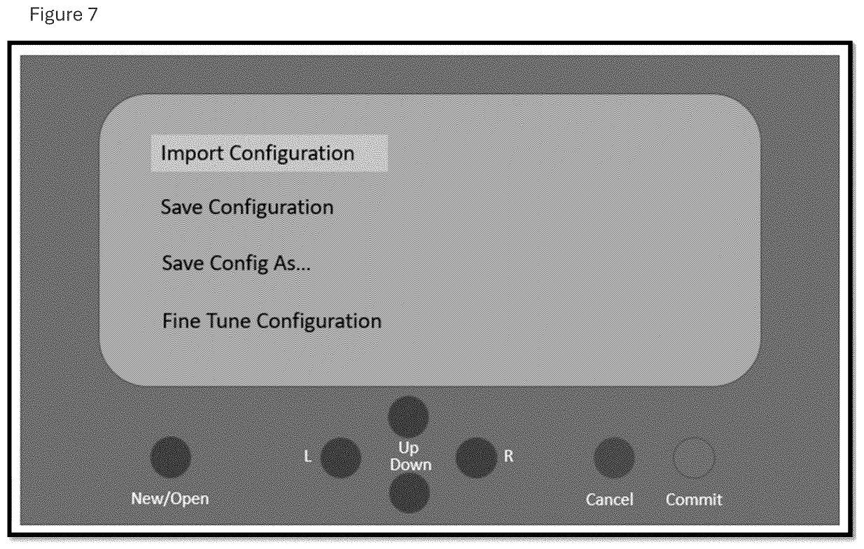

The configuration unit stores and displays the copedent settings. The CU may include a lit screen, push buttons or touch screen, a storage medium (e.g. SD card), and an interface cable. The unit may be housed in a small case that can be used in the palm of the hand or mounted within reach of the player for quick access. The ability to choose Left, Right, Up, Down, Select (see FIG. 7) and other functions present on the CU and enable the player to interface with the information on the screen.

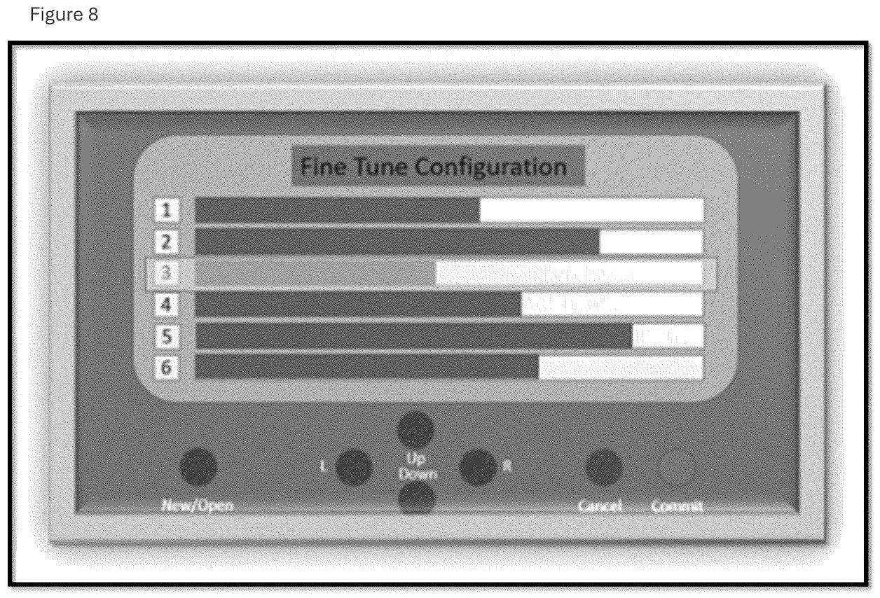

The configuration interface enables the user to perform a range of functions. The primary function is to recall a previously saved configuration. Other functions include creating a new copedent (i.e. the relationship between pedals, servo motors, and strings), saving an updated configuration, and lastly fine-tuning a configuration. FIG. 8 is an example of the interface of the configuration interface to fine-tune a configuration. In FIG. 8 the horizontal bars correspond to the six strings on a guitar.

The interface cable makes a connection between the CU and the logic controller (normally attached to the PU). The configuration interface then enables the player to use the buttons and the screen to recall, adjust, or store a configuration, aka: copedent.

Recalling, or loading, a copedent from stored media sets the copedent to active status. In one embodiment the active copedent sets the active pedals, the active motors, assigns pedals to motors, sets the initial position of each active motor, and sets the motors range based on the values set during fine-tuning. The active configuration is maintained in the PU such that the copedent will be active if the MISB is powered off and back on. This enables a player, if chosen, to set up and fine-tune the MISB, disconnect the CU, and potentially use the active copedent permanently without needing to reconnect the CU until a further config change is needed. The operation of the CU, including the fine-tuning process, will be described below.

In order to effect the tension change on a string, the MISB interprets a change in the value of a potentiometer and makes the associated change in a motor to move it a specific number of degrees. This associated change is being implemented 1) to emulate the feeling of pressing a mechanical pedal and 2) to emulate the additional pressure (or release of pressure) on a guitar string that pedal steel mechanicals apply to get a very specific change in pitch. This relationship between the potentiometer and electric motor is repeated multiple times, or simultaneously, so that multiple strings can be played and/or changed to provide a dynamic musical outcome from the guitar.

In the pedal unit, linear potentiometers are used to provide the signal change. By nature, a potentiometer is a variable resistor such that it increases and decreases resistance depending on its position and consequently changes the output voltage. Linear potentiometers remove the need for additional mechanical components such as those needed to change linear motion to lateral motion (e.g., gears, pulleys, and toothed rods).

A servo motor is designed to detect its position in degrees at any given time and to be able to receive an instruction, in digital signal, to set itself to a specific degree value. Diverse types of servo motors have various capabilities including the number of degrees of range, the speed of movement, the strength of movement, and power requirements. Examples of servo motors applicable to the MISB are listed below:
SunFounder SF3218MG
ANNIMOS DS3218MG
Smraza SG90
Deegoo-FPV MG99

The relationship between the analog input of the potentiometers and the digital output to the servo motors is controlled by a logic controller. The main logic controller is selected based upon considerations such as low power requirements, relative speed, small size while having at least 6 analog and 6 digital ports required for the MISB application. The current iteration of the MISB in one embodiment leverages the Arduino Nano platform, but other logic controllers may be deployed in other iterations.

The Arduino logic controller is a low-cost and standard platform to interact with sensors and actuators. The boards are equipped with sets of digital and analog input/output (I/O) pins that may be interfaced to various expansion boards, breadboards, and other circuits.²

The logic for the system, which is written in a programming language and stored in the logic controller, takes an input from an analog port, determines its relative position by voltage measurement, translates that into a value from a number range, and sends the resulting value to the appropriate digital port which, in turn, communicates it to the associated servo motor.

In the MISB design, each control in the pedal unit is connected to one analog input port on the logic controller. The analog input port has the capability to measure the amount of current, in volts, on the input port. The logic controller, in turn, detects and translates the voltage value supplied by the potentiometer in the pedal to a number in a range.

Each servo motor in the guitar unit is connected to one digital port on the logic controller or separate motor driver board. A digital port has the capability to send a digital signal of distinct types. In our case, each digital port consistently sends a number to the servo to indicate the point in the range where the motor should point. With the MISB, this range is limited between a base value, typically a number greater than zero, and the upper value, typically less than 180. These values are set during fine-tuning which is covered in the next section.

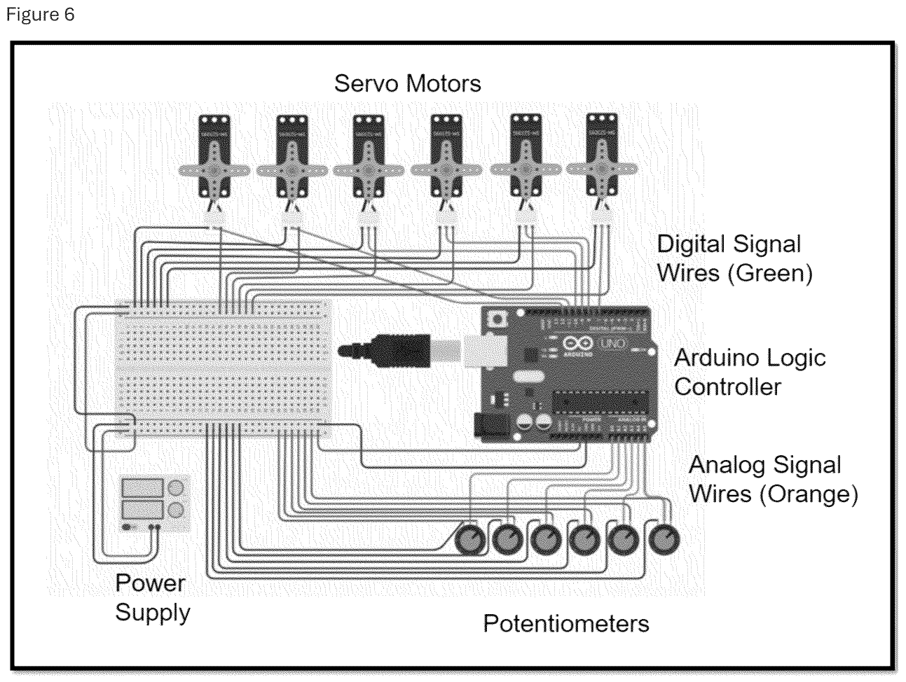

With leveraging the Arduino Nano controller, a limit of six controls is currently specified with the MISB due to limitations of the processor and wiring. For this reason, the PU is also designed for a maximum of six controls. The limitation of six inputs and six outputs is a limitation at this time but is not a required design standard. This limit is accepted since it corresponds to a normal 6-string fretted guitar and lap steel. The limit of six also corresponds to limitations of space in the guitar unit as well as the number of available signal wires in a standard CAT5/RJ45 cable. I. This limitation may be removed in other iterations using other controllers. Feasibility and benefit can be evaluated as future innovations are implemented. FIG. 6 provides a high-level wiring diagram (depicting support for the GU only).

In one embodiment, the CU provides these functions:
1) Recalling, Storing, and adjusting a copedent for the MISB
2) Communicating configuration to the pedal unit
3) Fine-tuning and updating the copedent

Because the MISB is designed to be dynamic, an interface to configure and tune the device is required for initial setup and periodic changes. Likewise, the CU is not required for a MISB-enabled guitar. Once the configuration is set, fine-tuned, and stored to the pedal unit, the configuration unit can be disconnected. The last copedent/configuration will be loaded if the device is turned off and back on without the need of the Configuration Unit. For any recalling, configuration, or fine-tuning the CU must be attached.

The Configuration interface runs on the configuration unit and enables the player to “call up” a configuration, save a new configuration, or edit and save/update a configuration. FIG. 7 provides an example of this interface. The configuration unit is made up of a small screen, a series of selection buttons (icons), and an SD Card reader or similar memory device. The configuration unit has the role of opening a configuration (copedent) file and flashing the stored configuration into the MISB's flash memory and/or saving the current configuration to a new or an existing copedent file.

In a given configuration (or copedent) the MISB will have strings where pressure is applied to change the pitch upward. Other strings, where the base configuration applies pressure to the string at base tuning will release pressure when the level is deployed-dropping the pitch of the string during play.

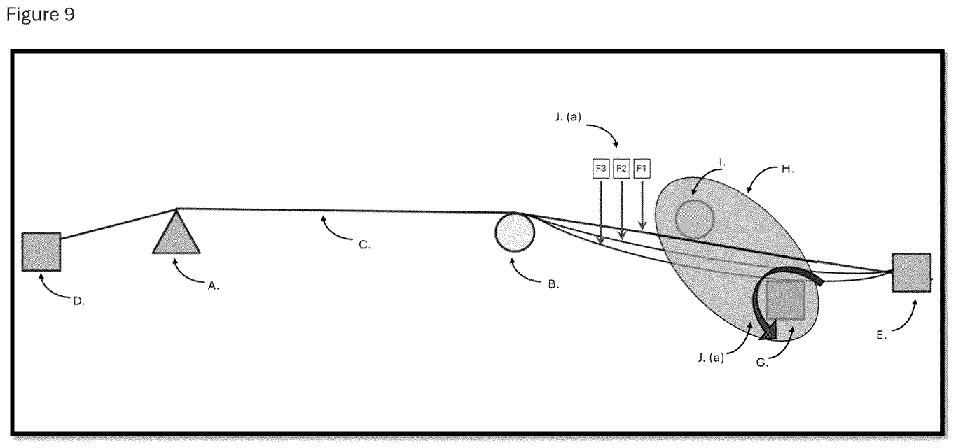

The configuration interface also enables fine-tuning. The purpose of “tuning” the configuration is similar, but not the same, as setting the base tuning of the guitar. Tuning the configuration refers to adjusting the starting and ending position of the motors to assure the resulting pitch, once the lever (control) is deployed, is exactly as the player chooses it to be. FIG. 9 illustrates the process of fine-tuning. In FIG. 9:
A. The guitar “nut” which is the end of the string tonal expanse.
B. The roller bridge which is the beginning of the tonal expanse.
C. The tonal expanse of the guitar is the portion of the string that is making a musical note.
D. String anchor at the far end of the guitar. This could also be a guitar tuner.
E. String anchor is a part of the MISB and holds strings in place once threaded.
G. Drive shaft of the MISB
H. The cam attached to the drive shaft of the MISB
I. String tensioner within the cam of the MISB
J. Represents forces being applied from the drive shaft, via the cam, and onto the string. String forces are represented by the boxes labeled F1, F2, and F3.

Fine tuning is meant to adjust the angle of the cam against a string to set the pitch to the exact desired level when a control is fully deployed. The guitar's base tuning, which refers to the tune of a string without any pressure being applied by the MISB, must be set before beginning. This is represented as F1. To fine tune the MISB for the guitar and copedent the player selects a string using the buttons then uses the up and down buttons to change motor angle to adjust the string pitch. The pitch is measured using the player's standard method (e.g., electronic tuner).

Once the base note is correct, the goal is to set the tensioner as close as possible to the string without any force on the string. This will be the start position and the Set button can be pushed to store the start value. To setting the end note, the fine-tuning interface is used to move the servo motor slowly toward F2 which represents the force required to make the desired end note when the associated pedal is pressed. As the button is pushed to increase the angle of the servo motor, the tensioner will apply tension to the string and move toward the string tension at F2. Once the end note is correct the Set button should be pressed. As the button is pushed, the end note will begin to move toward F3 and will become sharp compared to the desired end note. At this point the opposite (left) button can be used to move back to F2. Once at F2 and the Set button is complete for the current string.

This process is repeated for each string. Once all strings are completed the Store or Commit button must be pushed to store the configuration. The configuration can be stored to the running configuration or stored into a new configuration in storage.

An example scenario may be as follows: string #3 has a base tuning of G# with desired resulting note of A once pedal B is fully deployed. The player tunes string #3 to G# using a tuning device and the guitar's mechanical tuners. The player navigates to the fine-tuning panel in the Configuration interface in FIG. 8 and selects string #3. String #3 reflects a 50% value at this point. The player uses their normal tuner, deploys pedal B, and plucks string #3. If the note is exactly “A” then nothing is required. If the result is flat of A then the player will press the Up button to increase the angle of the servo motor and repeat pressing the Up button until the result is exactly the A note. The player repeats the process for all strings in the current copedent. Once complete the player presses the commit button to store the changes to the configuration into memory. Because it is saved in memory, the MISB will come back to this configuration indefinitely through power cycling of the device.

The MISB uses a DC power supply with a minimum of 5 volts and roughly 3 amps of power. With six motors, typically operating at different times, this power level will supply the system with adequate power to operate effectively. The Arduino Nano logic controller will also draw from the 5-volt system needing a nominal amount of current (approx. 250 mA).

The MISB may employ a power converter that can transform volts and amps from a DC power supply producing up to 24 volts. In one case, the power supply provides between about 5 and 9 volts and a minimum of about 15 watts of power. The barrel may be: 5.5 mm×2.1 mm (applicable 2.5 mm) and positive (+) center. In this instance the system will provide 3 amps of power of draw through this converter. In this case, performance may degrade with the Arduino and all 6 motors operating simultaneously. Because human limitations prevent simultaneous operation of controls, this limitation is unlikely to ever be an issue.

Having described the invention in detail and by reference to specific embodiments thereof it will be apparent that numerous modifications and variations are possible without departing from the spirit and scope of the invention defined by the following claims.

What is claimed is:

1. A bender for altering the pitch of a musical instrument including a plurality of strings substantially independently adjustable by the bender, thereby enabling the strings to vibrate at a plurality of pitches;
at least one pedal or lever;
at least one linear potentiometer responsive to movement of a pedal or lever,
the potentiometer being able to produce output voltage signals;
a servo motor associated with one or more potentiometers;
at least one cam capable of engaging one of the strings;
a logic controller configured and programmed to control the relationship between the potentiometer voltage output and a servo motor(s) such that the servo motor moves a cam into and/or out of engagement with the associated string and thereby modifies the pitch of that string;
by modifying the engagement of the cam and the string based on the position of the servo motor.

2. The bender of claim 1 including a configuration unit providing a configuration interface to recall, save, edit or update a configuration of the logic controller to set specific instruction for the servo motor(s).

3. The bender as defined in claim 2 wherein the pedal or lever is moved by a person.

4. The bender as defined in claim 2 wherein a configuration setting is stored in digital memory accessible by the logic controller.

5. The bender as defined in claim 4 wherein a copedent is stored on digital media and given a specific recallable identifier.

6. The bender of claim 1 wherein the relationship between the servo motor and the potentiometer is based on an instruction from the logic controller.

7. The bender of claim 1 wherein there are servo motors and potentiometers in a number to operate with common guitars with between 6 to 10 strings.

8. In a guitar having a bender for altering the pitch of at least one string on the guitar, the improvement wherein the bender comprises at least one pedal or lever;
at least one linear potentiometer responsive to movement of a pedal or lever,
the potentiometer being able to produce output voltage signals;
a servo motor associated with one or more potentiometers;
at least one cam capable of engaging one of the strings;
a logic controller configured and programmed to control the relationship between the potentiometer voltage output and a servo motor such that the servo motor moves a cam into and/or out of engagement with the associated string and thereby modifies the pitch of that string; by modifying the engagement of the cam and the string based on the position of the servo motor.

9. The guitar of claim 1 further including a configuration unit providing a configuration interface to recall, save, edit or update a configuration of the logic controller to set specific output voltages for the servo motor(s).

10. The guitar as defined in claim 9 wherein the pedal or lever is moved by a person.

11. The guitar as defined in claim 10 wherein a configuration setting is stored in digital memory onto the logic controller or removeable digital storage.

12. The guitar as defined in claim 11 wherein a copedent is stored on digital media and given a specific recallable identifier.

13. The guitar of claim 8 wherein the relationship between the servo motor and the potentiometer is based on an instruction from the logic controller.

14. The guitar of claim 8 wherein there are servo motors and potentiometers in a number to operate with common guitars with between 6 to 10 strings.

15. The bender of claim 2 wherein the configuration unit communicates to the logic controller by means of a wireless connection.
